(19) United States
(12) Patent Application Publication
(10) Pub. No.: US 2026/0038157 A1
(43) Pub. Date: Feb. 5, 2026

(54) RATE DISTORTION OPTIMIZATION FOR TIME VARYING TEXTURED MESH COMPRESSION

(71) Applicant: InterDigital CE Patent Holdings, SAS, Paris (FR)

(72) Inventors: Jean-Eudes MARVIE, PLERIN (FR); Franck GALPIN, Cesson-Sevigne (FR); Olivier MOCQUARD, Cesson-Sevigne (FR); Francois-Louis TARIOLLE, Cesson-Sevigne (FR)

(21) Appl. No.: 19/101,489

(22) PCT Filed: Jul. 28, 2023
(86) PCT No.: PCT/EP2023/070996

§ 371 Date: Feb. 5, 2025

(30) Foreign Application Priority Data
Aug. 17, 2022 (EP) 22306231.6

(51) Int. Cl. G06T 9/00; H04N 19/124; H04N 19/147; H04N 19/172; H04N 19/184; H04N 19/192; H04N 19/597

(52) U.S. Cl. CPC G06T 9/001; H04N 19/124; H04N 19/147; H04N 19/172; H04N 19/184; H04N 19/192; H04N 19/597

(57) ABSTRACT

Apparatuses and methods are disclosed for encoding mesh data. Techniques disclosed include receiving a sequence of frames, each of which includes mesh data. For a frame in the sequence, techniques disclosed for encoding the mesh data of the frame according to a static path and according to a motion path of a multipath encoder, computing a static path cost of the encoding according to the static path and a motion path cost of the encoding according to the motion path, where the costs are computed by optimizing a rate-distortion cost function, and selecting, based on the computed motion path cost and static path cost, a bitstream generated by the encoding according to the motion path or a bitstream generated by the encoding according to the static path.

### CROSS REFERENCE TO RELATED APPLICATIONS

This application claims the benefit of European Application No. EP22306231.6, filed on Aug. 17, 2022, which is incorporated herein by reference in its entirety.

### BACKGROUND

Computer generated or camera captured objects are commonly modeled by dynamic meshes. A significant amount of data is required for high quality representation and rendering of content containing dynamic meshes. Moreover, efficient compression techniques are instrumental in delivering such content to consumers and in storing it. Generally, a mesh is composed of geometrical data representing the topology of a surface and attribute data representing physical properties of the surface. The geometrical data of a mesh can be encoded directly or relative to a reference mesh. Since the distortion introduced by compressing the geometrical data affects the distortion introduced by compressing the attribute data, the choice between a direct or a relative encoding of the geometrical data impacts the overall mesh compression efficiency. Selecting between a direct or a relative encoding thus should be carried out in a manner that improves the overall encoding performance.

### SUMMARY

Aspects disclosed in the present disclosure describe methods for encoding mesh data. The methods comprise receiving a sequence of frames, each including mesh data. For a frame in the sequence, the methods further comprise encoding the mesh data of the frame according to a static path and according to a motion path of a multipath encoder, computing a static path cost of the encoding according to the static path and a motion path cost of the encoding according to the motion path, where the costs are computed by optimizing a rate-distortion cost function, and then selecting, based on the motion path cost and the static path cost, a bitstream generated by the encoding according to the motion path or a bitstream generated by the encoding according to the static path.

Aspects disclosed in the present disclosure describe an apparatus for encoding mesh data. The apparatus comprises at least one processor and memory storing instructions. The instructions, when executed by the at least one processor, cause the apparatus to receive a sequence of frames, each including mesh data. For a frame in the sequence, the instructions further cause the apparatus to encode the mesh data of the frame according to a static path and according to a motion path of a multipath encoder, to compute a static path cost of the encoding according to the static path and a motion path cost of the encoding according to the motion path, where the costs are computed by optimizing a rate-distortion cost function, and then to select, based on the motion path cost and the static path cost, a bitstream generated by the encoding according to the motion path or a bitstream generated by the encoding according to the static path.

Aspects disclosed in the present disclosure describe a non-transitory computer-readable medium comprising instructions executable by at least one processor to perform methods for encoding mesh data. The methods comprise receiving a sequence of frames, each including mesh data. For a frame in the sequence, the methods further comprise encoding the mesh data of the frame according to a static path and according to a motion path of a multipath encoder, computing a static path cost of the encoding according to the static path and a motion path cost of the encoding according to the motion path, where the costs are computed by optimizing a rate-distortion cost function, and then selecting, based on the motion path cost and the static path cost, a bitstream generated by the encoding according to the motion path or a bitstream generated by the encoding according to the static path.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

FIG. 1 is a functional block diagram of an example system for dynamic mesh encoding, according to an aspect of the present disclosure.

FIG. 2 is a functional block diagram of an example system for dynamic mesh decoding, according to an aspect of the present disclosure.

FIG. 3 is a functional block diagram of an example base mesh encoder, according to an aspect of the present disclosure.

FIG. 4 is a functional block diagram of an example base mesh decoder, according to an aspect of the present disclosure.

FIG. 5 is a functional block diagram of an example multipath encoder, according to an aspect of the present disclosure.

FIG. 6 is a diagram of an example group of pictures structure, according to an aspect of the present disclosure.

FIG. 7 is a diagram of an example method for determining static frames in a group of pictures, according to an aspect of the present disclosure.

FIG. 8 is a flow diagram of an example method for multipath encoding.

### DETAILED DESCRIPTION

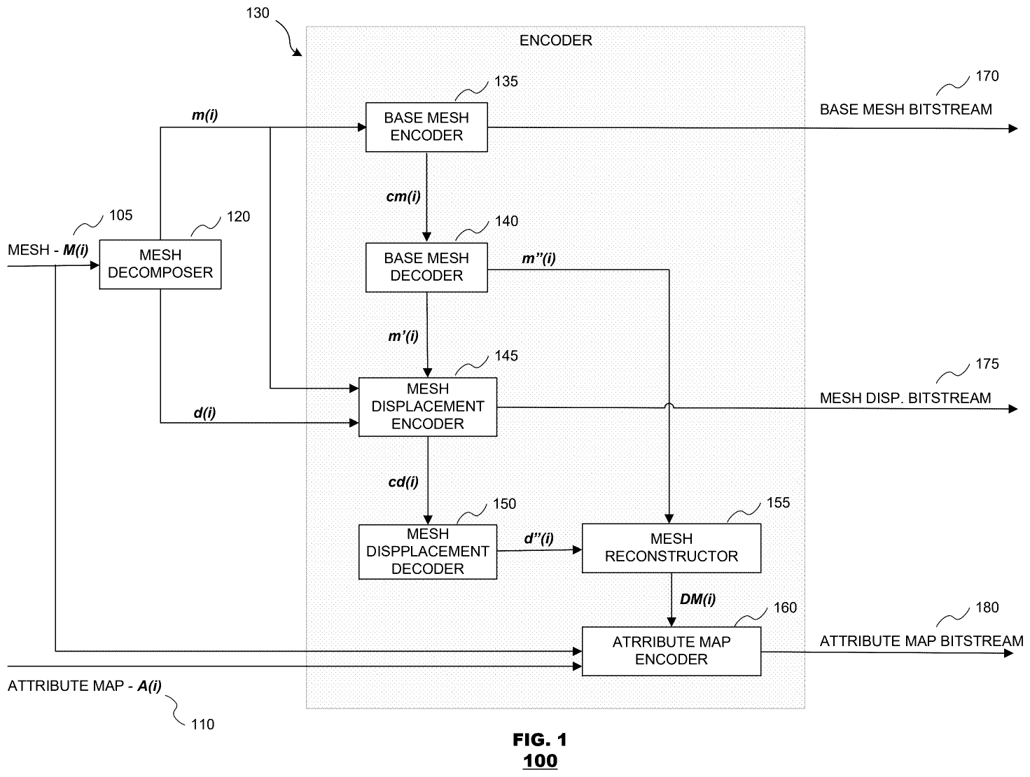

Following the MPEG V-Mesh CfP, the solution described by Mammou et al. (“Mammou”) was selected to become the foundation of the MPEG V-Mesh Test Model. See, K. Mammou, J. Kim, A. Tourapis and D. Podborski, m59281-[V-CG] Apple's Dynamic Mesh Coding CfP Response, Apple Inc, 2022. Mammou's proposed dynamic mesh coding is described herein in reference to FIGS. 1-4. As further described herein, the proposed dynamic mesh coding suggests first encoding the mesh's geometrical data: i) directly and ii) relative to a reference mesh, and, then, choosing the encoding method (either direct or relative encoding) that results in the least geometrical distortion. However, this approach does not take into consideration how each coding method impacts distortions introduced by the encoding of non-geometrical data associated with the mesh (e.g., textural data) or the bitrate of the coded data's bitstream.

Apparatuses and methods are disclosed for encoding a sequence of frames containing mesh data. Aspects of a multipath encoder are described herein, including encoding mesh data according to a static path and according to a motion path. The bitstream generated by the encoding path that yields the more efficient compression is selected, where efficiency is measured by a rate-distortion cost function. The rate distortion cost function includes geometrical terms and textural terms, and, thus, takes into consideration the overall impact of encoding according to the static path and encoding according to the motion path, enabling a more efficient selection of an encoding path. Additionally, disclosed herein is an adaptation of a group of pictures (GOP) structure of the sequence of frames based on the respective selected encoding paths.

Generally, a mesh is a representation of a surface's topology, including vertices that are associated with three-dimensional (3D) locations on the surface: the vertices are connected by edges, forming planar surfaces (such as triangles) that approximate the surface. Other information may be associated with each of the mesh's vertices, namely, vertex attributes (e.g., a normal vector and a color value). In addition to its topology, the surface can be further represented by various attributes, such as texture. Typically, the surface's texture is described by a two-dimensional (2D) image, that is, a texture map. To associate the mesh's surface with corresponding texture data, the mesh's 3D surface is mapped into a 2D space (e.g., a UV parametric space). Similarly, the mesh's surface can be associated with other data types, provided by other attribute maps, characteristic of other physical properties of the surface (e.g., surface reflectance and transparency) that may be required for realistic rendering of the surface. Thus, surface representation by mesh data includes topological data and attribute data—the topology of a surface is represented by a mesh M (including geometry and connectivity information, and, possibly, vertex attributes) and the attributes of the surface represented by attribute maps A (including the attribute maps and respective mapping information). Aspects described herein with respect to textural data (represented by textural maps) are applicable to other types of data (generally represented by attribute maps).

FIG. 1 is a functional block diagram of an example system 100 for dynamic mesh encoding, according to an aspect of the present disclosure. The system 100 illustrates the encoding of a frame sequence F(i), where data associated with frame i include a mesh M(i) 105 and corresponding attribute map(s) A(i) 110. The system 100 includes a mesh decomposer 120 (e.g., a part of a pre-processing unit) and an encoder 130. The mesh decomposer 120 is configured to decompose a received mesh M(i) 105 into a base mesh m(i) and corresponding displacement vectors d(i). The generated base mesh m(i) and displacement vectors d(i), together with the corresponding attribute map(s) A(i) 110, are then fed into the encoder 130. The encoder 130 encodes the obtained data—m(i), d(i), and A(i)—generating therefrom respective bitstreams, including a base mesh bitstream 170, a mesh displacement bitstream 175, and an attribute map bitstream 180. The operation of the mesh decomposer 120 and the operation of the encoder 130 are further described below.

The decomposer 120 is configured to decompose a mesh M(i) 105 into a base mesh m(i) and corresponding displacement vectors d(i). To generate a base mesh m(i), the decomposer 120 decimates the mesh M(i) by sub-sampling the mesh's vertices. A subdivided mesh is then generated by subdividing the base mesh m(i), that is, each surface of the base mesh is subdivided into multiple sub-surfaces, introducing additional new vertices. Any subdivision scheme may be applied, optionally, iteratively. For example, each triangle of the base mesh surface can be split into four sub-triangles by introducing three new vertices in the middle of the triangle's edges and by connecting those three vertices. Next, the decomposer 120 determines displacement vectors d(i) for respective vertices of the subdivided base mesh, so that when applied to those vertices, a deformed mesh is generated that spatially fits the received mesh M(i) 105. Decomposing the received mesh M(i) in this manner—to allow encoding of the base mesh m(i) and its corresponding displacement vectors d(i) instead of encoding directly the mesh M(i) 105—improves compression efficiency. This is because the base mesh has fewer vertices relative to the mesh M(i) 105, and, therefore, can be encoded by a relatively smaller number of bits. Furthermore, the displacement vectors can be efficiently encoded using, for example, a wavelet transform, enabled by the subdivision structure. In turn, the used subdivision structure need not be explicitly encoded as it can be determined by the decoder. For example, the decoder can subdivide the decoded base mesh based on a subdivision scheme type and a subdivision iteration count that can be signaled in the bitstream.

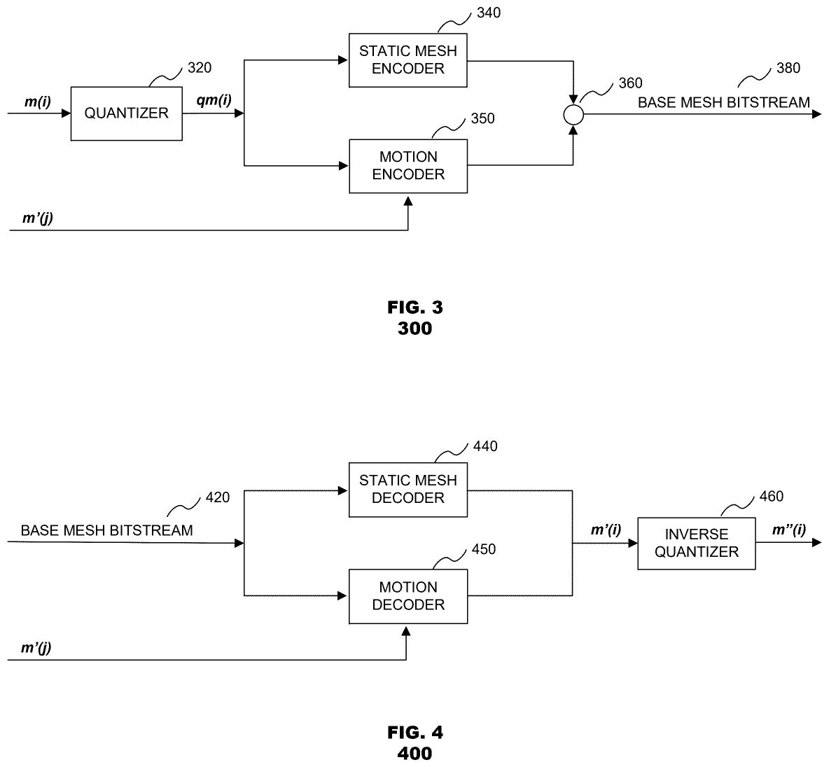

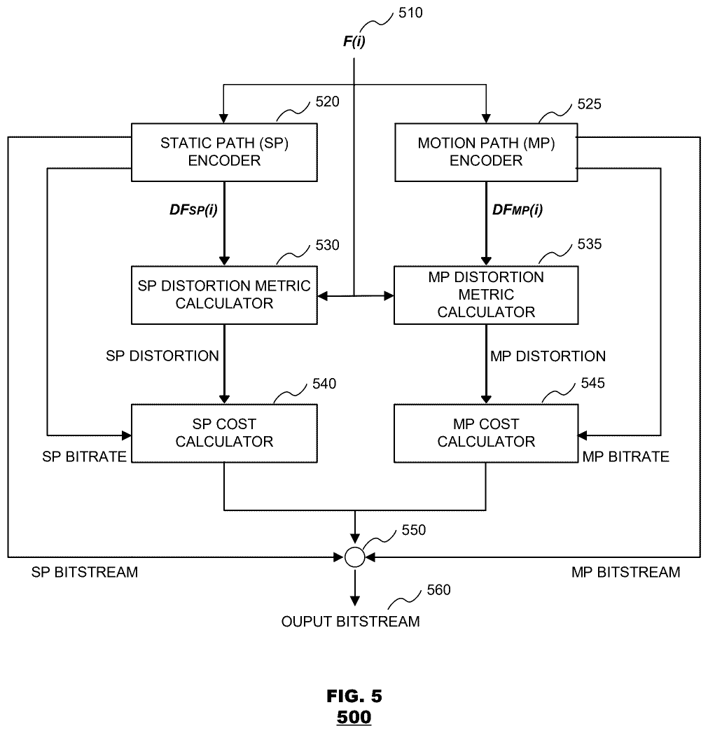

As illustrated in FIG. 1, the encoder 130 includes a base mesh encoder 135, a base mesh decoder 140, a mesh displacement encoder 145, a mesh displacement decoder 150, a mesh reconstructor 155, and an attribute map encoder 160. The base mesh encoder 135 is configured to encode the base mesh m(i) into coded base mesh cm(i) and to generate therefrom the base mesh bitstream 170). The base mesh decoder 140 is configured to reconstruct (decode) the base mesh from the coded base mesh cm(i), resulting in a reconstructed quantized base mesh m′(i) and a reconstructed base mesh m″(i). The base mesh encoder 135 and decoder 140 are further described in reference to FIG. 3 and FIG. 4, respectively. The mesh displacement encoder 145 receives as input the base mesh m(i) and the reconstructed quantized base mesh m′(i), based on which it is configured to encode the received displacement vectors d(i) into coded displacement vectors cd(i) and to generate therefrom the mesh displacement bitstream 175. The mesh displacement decoder 150 is configured to reconstruct (decode) the displacement vectors from the coded displacement vectors cd(i), resulting in reconstructed displacement vectors d″(i). Based on the reconstructed base mesh m″(i) and the reconstructed displacement vectors d″(i), the mesh reconstructor 155 is configured to reconstruct (decode) the mesh into reconstructed mesh DM(i). Based on the mesh M(i) and the reconstructed mesh DM(i), the attribute map encoder 160 is configured to encode the attribute map(s) A(i) into coded attribute map(s) and to generate therefrom the attribute map bitstream 180.

The mesh displacement encoder 145 encodes the displacement vectors d(i) that, as mentioned above, are associated with respective vertices of the subdivided base mesh. To that end, the displacement vectors are first updated based on the reconstructed quantized base mesh m′(i). Then, a wavelet transform is applied to the updated displacement vectors d′(i) according to the subdivision structure with which the base mesh has been subdivided. The wavelet coefficients are then quantized, packed into a 2D image, and compressed by a video encoder. The mesh displacement decoder 150 generally reverses the operation of the mesh displacement encoder 145. Accordingly, the mesh displacement decoder 150 employs a video decoder to decode the packed 2D image compressed by the video encoder of the mesh displacement encoder 145 (if the video encoder is lossy). Then, the mesh displacement decoder 150 unpacks the 2D image to obtain the quantized wavelet coefficients and applies inverse quantization followed by an inverse wavelet transform, generating the reconstructed displacement vectors d″(i).

Note that a video encoder is applied to the task of compressing the packed wavelet coefficients (by the mesh displacement encoder 145) and to the task of compressing the attribute map(s) (by the attribute map encoder 160). Any video encoding method (either lossless or lossy) may be employed for these tasks, in accordance with a specific application's requirements.

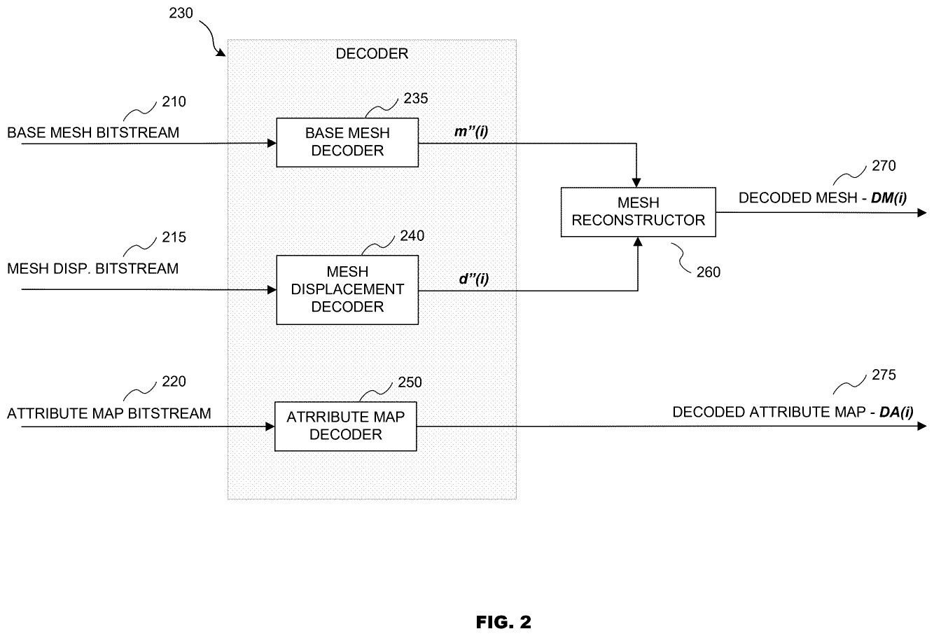

FIG. 2 is a functional block diagram of an example system 200 for dynamic mesh decoding, according to an aspect of the present disclosure. The system 200 is configured to generally reverse the operation of system 100, including a decoder 230 and a mesh reconstructor 260. The decoder 230 includes a base mesh decoder 235, a mesh displacement decoder 240, and an attribute map decoder 250. The base mesh decoder 235 decodes the reconstructed base mesh m″(i) out of the base mesh bitstream 210, 170, as further described in reference to FIG. 4. The mesh displacement decoder 240 decodes the reconstructed displacement vectors d″(i) out of the mesh displacement bitstream 215, 175, performing the steps described in reference to the mesh displacement decoder 150 of FIG. 1. The attribute map decoder 250 decodes the attribute map out of the attribute map bitstream 220, 180, reversing the operation of the attribute map encoder 160 to generate the reconstructed attribute map DA(i) 275. The decoder's 230 outputs of the reconstructed base mesh m″(i) and the reconstructed displacement vectors d″(i) are used by the mesh reconstructor 260 to reconstruct the decoded mesh DM(i) 270.

FIG. 3 is a functional block diagram of an example base mesh encoder 300, according to an aspect of the present disclosure. The base mesh encoder 300 includes a quantizer 320, a static mesh encoder 340, a motion encoder 350, and a selector 360. As described above in reference to the base mesh encoder 135 of FIG. 1, the base mesh encoder 300 is configured to encode a base mesh m(i) into a base mesh bitstream 380. To that end, two encoders 340, 350 may be employed. Accordingly, following quantization 320, the static mesh encoder 340 encodes the quantized base mesh qm(i) independently according to any static mesh encoding method. Additionally, following quantization 320, the motion encoder 350 encodes the quantized base mesh qm(i) relative to a reference reconstructed quantized base mesh m′(j) (e.g., associated with a previous base mesh m(i−1) of the frame sequence). That is, the motion encoder 350 encodes a motion field f(i) that describes the motion that vertices of m(j) have to undergo in order to reach respective locations of corresponding vertices of m(i).

Accordingly, it is assumed that m(i) and m(j) share the same number of vertices and the same vertex connectivity, while only the locations of corresponding vertices in m(i) and in m(j) change over time. In an aspect, to make sure that m(i) and m(j) have the same corresponding vertices, the encoder 300 may keep track of the transformation applied to m(j) to obtain m′(j) and apply the same to m(i). Under such conditions, the motion encoder 350 can be configured to first compute a motion field f(i), and then, encodes the computed motion field into the base mesh bitstream 380. The motion field f(i) contains motion vectors respective of corresponding vertices in the quantized base mesh qm(i) and the reference reconstructed quantized m′(j), as follows:

$$f ( i ) = {v}_{1} ( i ) - {v}_{2} ( j ) , \qquad ( 1 )$$

where v₁(i) is a vector containing positions of vertices of mesh qm(i) and v(j) is a vector containing positions of corresponding vertices of mesh m′(j). In an aspect, the motion encoder 350 may further adjust the motion vectors (e.g., based on neighboring motion vectors) and then encodes the adjusted motion vectors using an entropy coder, for example.

The choice whether to use the output of the static mesh encoder 340 or the output of the motion encoder 350) can be carried out by the selector 360. As mentioned above, Mammou proposes to select the bitstream of the encoder (either the static mesh encoder 340) or the motion encoder 350) that results in the least geometric distortion, using the D2 feature of the MPEG mesh metric. That is, if the geometric distortion contributed by the motion encoder 350 is lower than the geometric distortion contributed by the static mesh encoder 340 (or lower than a predetermined threshold) the bitstream generated by the motion encoder 350 will be used as the base mesh bitstream 380, otherwise the bitstream generated by the static mesh encoder 340) will be used as the base mesh bitstream 380. However, the used D2 feature of the MPEG mesh metric only reflects geometric distortion, and, for example, the global rate is not considered.

FIG. 4 is a functional block diagram of an example base mesh decoder 400, according to an aspect of the present disclosure. The base mesh decoder 400 generally reverses the operation of the base mesh encoder 300. It 400 includes a static mesh decoder 440), a motion decoder 450) and an inverse quantizer 460. As described above in reference to the base mesh decoder 235 of FIG. 2, the base mesh decoder 400 is configured to decode the reconstructed base mesh m″(i) out of the base mesh bitstream 420, 380. To that end, the base mesh decoder 400 directs an incoming base mesh stream 420) (representing a coded base mesh cm(i)) either to the static mesh decoder 440) or to the motion decoder 450. Such direction can be made based on signaling in the bitstream 420 indicative of whether the coded base mesh cm(i) was encoded by the static mesh encoder 340 or the motion encoder 350. If the bitstream 420 is directed to the static mesh decoder 440), the latter decodes the base mesh from the bitstream 420, resulting in the reconstructed quantized base mesh m′(i). Otherwise, if the bitstream 420 is directed to the motion decoder 450), the latter decodes the motion field from the bitstream 420) and adds the reconstructed (decoded) motion field f′(i) to the reference reconstructed quantized base mesh m′(j), resulting in the reconstructed quantized base mesh m′(i). The resulting m′(i) is then provided to the inverse quantizer 460 that generates therefrom the reconstructed base mesh m″(i). As described above, the base mesh decoder 400 is also employed in the encoder 130, where it 140 provides the reconstructed quantized base mesh m′(i) and the reconstructed base mesh m″(i) to the mesh displacement encoder 145 and the mesh reconstructor 155, respectively.

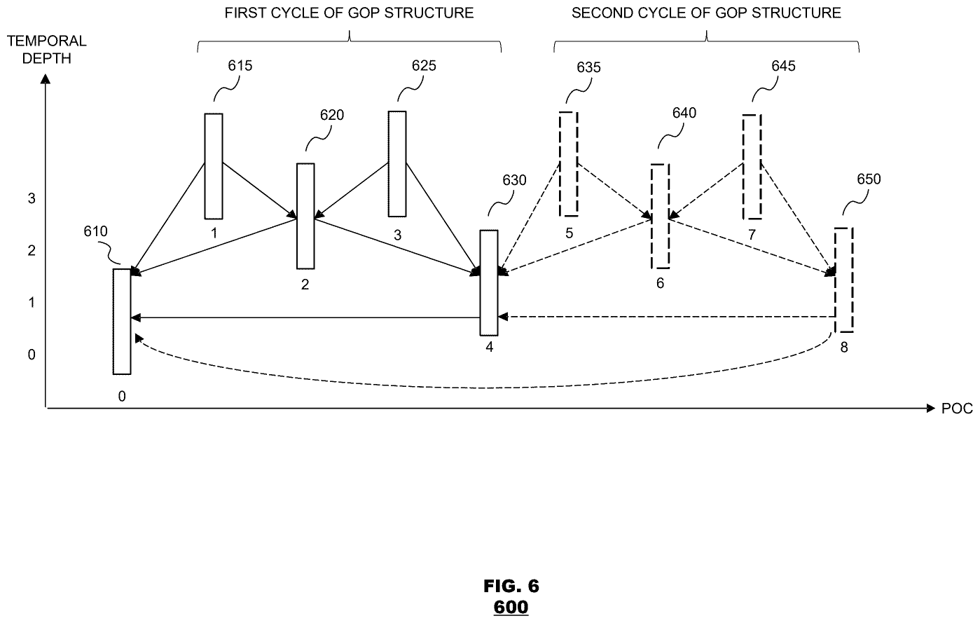

As mentioned above, the base mesh encoder 300 may choose 360 to encode the received base mesh m(i) of a frame i directly (employing the static mesh encoder 340) or may choose to encode the received base mesh m(i) relative to a reference base mesh m(j) (employing the motion encoder 350). In the latter, what is encoded is a motion field f(i) that relates corresponding vertices from m(i) and m(j). Using the D2 feature of the MPEG mesh metric, as described above, to determine geometric distortions—based on which a choice is made to employ either the static mesh encoder 340 or the motion encoder 350—may not result in the better choice, as other sources of cost that are introduced in the encoder 130 are not considered in this approach. A preferred approach is to consider the overall rate-distortion cost introduced by the encoder 130 when selecting between the output of the static mesh encoder 340 and the output of the motion path 350. Hence, according to aspects disclosed herein, a rate-distortion optimization, that accounts for topological and photometric distortions as well as bitrate levels, is performed. The employed rate-distortion optimization can lead to a selection of the encoder (340 or 350) that will provide more efficient coding, corresponding to optimal rate-distortion cost, as further described in reference to FIG. 5.

FIG. 5 is a functional block diagram of an example multipath encoder 500, according to an aspect of the present disclosure. The multipath encoder 500 includes a static path (SP) encoder 520 and a motion path (MP) encoder 525, each of which is configured to encode the mesh data of an incoming frame F(i) 510, including a mesh M(i) and corresponding attribute map(s) A(i). The SP encoder 520 may include components of the encoder 130 of system 100 (FIG. 1) and of the decoder 230 of system 200 (FIG. 2), where the static mesh encoder 340 and the static mesh decoder 440 are employed (referred to herein as the static path). The MP encoder 525 may include components of the encoder 130 of system 100 (FIG. 1) and of the decoder 230 of system 200 (FIG. 2), where the motion encoder 350 and motion decoder 450 are employed (referred to herein as the motion path). As illustrated in FIG. 5, the SP encoder 520 outputs the decoded frame, denoted DF_{SP}(i), as well as the respective SP bitstream and its bitrate (i.e., SP bitrate). Likewise, the MP encoder 525 outputs the decoded frame, denoted DFMP (i), as well as the respective MP bitstream and its bitrate (i.e., MP bitrate).

The multipath encoder 500 further includes an SP distortion metric calculator 530 that computes the various distortions introduced by the SP encoder 520 based on the frame F(i) 510 and its decoded version DF_{SP}(i). Likewise, the multipath encoder 500 includes an MP distortion metric calculator 535 that computes the various distortions introduced by the MP encoder 525 based on the frame F(i) 510 and its decoded version DFMP (i). An SP cost calculator 540 of the multipath encoder 500 is configured to compute the rate-distortion cost of employing the SP encoder 520 based on the SP distortion (provided by the SP distortion metric calculator 530) and based on the SP bitrate of the SP bitstream. Likewise, an MP cost calculator 545 is configured to compute the rate-distortion cost of employing the MP encoder 525 based on the MP distortion (provided by the MP distortion metric calculator 535) and based on the MP bitrate of the MP bitstream. Based on those computed rate-distortion costs 540, 545, a selector 550 is configured to select either outputting the SP bitstream as the output bitstream 560 of the multipath encoder 500 or outputting the MP bitstream as the output bitstream 560 of the multipath encoder 500, as illustrated in FIG. 5. Note that, a frame F(i) for which the SP bitstream is selected is referred to herein as a static frame that is encoded in a static mode, while a frame F(i) for which the MP bitstream is selected is referred to herein as a motion frame that is encoded in a motion mode.

To select between a static path 520 and a motion path 525 when encoding an incoming frame F(i)∈M(i), A(i), a coding cost J associated with each alternative path is computed, and through an optimization process, the path (either the static path 520 or the motion path 525) that results in the lower optimal cost (or having an optimal cost below a predetermined threshold) is selected. The used coding cost may be the following rate-distortion cost function:

$$J = D + λ R , \qquad ( 2 )$$

where, D is a distortion metric, R a bitrate value, and λ is a Lagrange multiplier. The Lagrange multiplier λ allows to set a tradeoff between the quality of the coded data (inversely proportional to the distortion D) and the bitrate R. For example, λ can be a function of a quantization parameter (QP) used by a quantizer of an encoder (e.g., λ∝e^{(((QP-3)/6)))}). In an aspect, multiple Lagrange multipliers can be used to balance distortions introduced by quantizers of various encoders (e.g., the base mesh encoder 135, the mesh displacement encoder 145, and/or the attribute map encoder 160) and respective bitrates.

The distortion metric D can be computed as:

$$D = {D}_{tex} + α {D}_{geo} , \qquad ( 3 )$$

where Dₜₑₓ represents texture distortion and D_{geo} represents geometrical distortion. The parameter a can be set to balance between the texture distortion and the geometrical distortion. For example, the texture distortion can be expressed as:

$${D}_{tex} = ( {β}_{Y} {D}_{Y} + {β}_{U} {D}_{U} + {β}_{V} {D}_{V} ) / ( {β}_{Y} + {β}_{U} + {β}_{V} ) , \qquad ( 4 )$$

where, D_{Y}, D_{U}, and D_{V} denote respective distortion values contributed by the coding of luma Y and chroma components U and V of a texture map. The corresponding weighting values β_{Y}, β_{U}, and β_{V} can be used to balance the different distortion sources. For example, to balance the luma distortion value D_{Y} against the chroma distortion values D_{U}, and D_{Y}, the weighting values can be set to β_{Y}=6 and β_{U}=β_{V}=1. A distortion D is typically measured by a mean squared error (MSE) metric-that is, the average of squared error values that are derived based on a distance metric, measuring the difference between samples from the original data (e.g., a texture map) and corresponding samples from the reconstructed data (e.g., a reconstructed texture map).

As disclosed herein, the rate-distortion optimization process is carried out by minimizing a cost function, J, over various coding modes (i.e., modes). The optimal cost J can be computed with respect to the static path 540 and with respect to the motion path 545. Based on these optimal costs it may be determined which bitstream (SP bitstream or MP bitstream) is selected as an output bitstream 560 (see FIG. 5). In an aspect, a cost function includes the textural and geometrical distortions and the various bitrates, associated with respective bitstreams 170, 175, 180 generated by the encoder 130. The optimization of such a cost function can be expressed as follows:

$$J = {min}_{modes} ( {D}_{tex} + α {D}_{geo} + λ ( {R}_{tex} + {R}_{geo} ) ) , \qquad ( 5 )$$

where, λ is the Lagrange multipliers. The term Dₜₑₓ is a texture distortion (e.g., associated with reconstructed attribute map(s) DA(i)) and the term D_{geo} is a geometrical distortion (e.g., associated with the reconstructed mesh DM(i)). The term Rₜₑₓ is a bitrate of a bitstream that represents textural data (e.g., 180) and the term R_{geo} is a bitrate of a bitstream that represents geometrical data (e.g., 170, 175). The coding modes over which the cost function J is optimized can include any set of parameters that can control the operation of the encoder 130 and its components 135, 145, 160. Note that when the cost function is optimized with respect to the static path, the term R_{geo} includes:

$${R}_{geo} = {R}_{geo}^{static} = {R}_{mesh} + {R}_{displacement} , \qquad ( 6 )$$

and when the cost function is optimized with respect to the motion path, the term R_{geo} includes:

$${R}_{geo} = {R}_{geo}^{motion} = {R}_{motion} + {R}_{displacement} . \qquad ( 7 )$$

Where, Rₘₑₛₕ and Rₘₒₜᵢₒₙ are the bitrates of the base mesh bitstream 170 when generated by the static path and when generated by the motion path, respectively. And, where R_{displacement} is the bitrate of the mesh displacement bitstream 175.

In an aspect, other distortion metrics, D, can be used in optimizing the rate-distortion cost function J. Two MPEG distortion metrics can be used to obtain distortion values. See MDS21000_WG07_N00231, CfP for Dynamic Mesh Coding, MPEG, 2021 Nov. 8. Those metrics can be extended by applying them to data from several neighboring frames. The two metrics are described below.

In a first metric, namely, a point cloud based mesh distortion (PCMD) metric, to compute the point cloud, the mesh M(i) and the reconstructed mesh DM(i) are geometrically sampled into a colored point cloud using their respective texture maps, A(i) and DA(i). Then, the colored point cloud is used to compute geometrical distortion measures: MSE_{D1} and MSE_{D2}, and textural distortion measures MSE_{Y}, MSE_{U}, and MSE_{V}. Note that, as demonstrated by the architecture of the encoder 130 of FIG. 1, textural distortions are normally affected by geometrical distortions. Those distortion measures can be combined into a single metric, homogeneous to the MSE_{Y}, as follows:

$$PCMD = ( a {MSE}_{D 1} + b {MSE}_{D 2} + c {MSE}_{Y} + d {MSE}_{U} + e {MSE}_{V} ) / c \qquad ( 8 )$$

Where, the coefficients a, b, c, d, and e can be determined as described below.

In a second metric, namely, an image based sampling distortion (IBSD) metric, the mesh M(i) and the reconstructed mesh DM(i) are rendered from several different points of view using their respective attribute maps. The rendered views are then used to compute a geometrical distortion measure MSE_{geo} and textural distortion measures MSE_{Y}, MSE_{U}, and MSE_{V}. As mentioned above, textural distortions are normally affected by geometrical distortions. Those distortion measures can be combined into a single metric, homogeneous to the MSE_{Y}, as follows:

$$IBSD = ( {a}^{′} {MSE}_{GEO} + {b}^{′} {MSE}_{Y} + {c}^{′} {MSE}_{U} + {d}^{′} {MSE}_{V} ) / {b}^{′} , \qquad ( 9 )$$

where, the coefficients a′, b′, c′, and d′ can be determined as described below.

To determine coefficients a, b, c, d, and e of eq. (8) and coefficients a′, b′, c′, and d′ of eq. (9), a learning process can be utilized, for example, by using perceptual mean opinion scores (MOS) collected from a group of persons. For example, each person from a group of persons can be asked to evaluate a total of N videos, where M animated models were rendered using several distortion types and a number of distortion levels per each distortion type. Then, the coefficients a, b, c, d, and e can be estimated based on the collected evaluations and respective computed PCMD metrics. Similarly, the coefficients a′, b′, c′, and d′ can be estimated based on the collected evaluations and respective IBSD metrics. In an aspect, the coefficients' estimation is performed using a leave-one-out cross validation and learning. Note that any other learning method can be used to estimate the values of the coefficients.

Additional distortion measures can be added to the PCMD and the IBSD metrics, such as distortion measures that detect specific defects of interest (e.g., cracks in the reconstructed mesh surface). Additionally, the distortion measures can be combined linearly or nonlinearly by any function to produce the PCMD metric or the IBSM metric. Note that the measures in both the PCMD metric and the IBSM metric are scaled to the MSE_{Y} scale.

As disclosed herein, the optimization process according to eq. (5) can be simplified by first optimizing the cost associated with encoding geometrical data and then proceeding to optimize the total cost. To that end, the rate-distortion cost J can be expressed as follows:

$$J = {min}_{g e o - modes} ( {D}_{g e o} + {λ}^{′} {R}_{g e o} ) + {min}_{t e x - modes} ( {D}_{tex} + λ ( {R}_{g e o}^{mode} + {R}_{t e x} ) ) . \qquad ( 10 )$$

Where, λ and λ′ are the Lagrange multipliers. The term D_{geo} is a geometrical mesh distortion (e.g., associated with the reconstructed mesh DM(i)) and the term Dₜₑₓ is a mesh texture distortion (e.g., associated with the reconstructed attribute map(s) DA(i)). The term Rₜₑₓ is the texture bitrate of the attribute map bitstream 180. As mentioned above, the term R_{geo} equates with

$${R}_{g e o}^{static} = {R}_{m e s h} + {R}_{displacement}$$

when optimizing the cost for the static path and equates with

$${R}_{g e o}^{motion} = {R}_{m o t i o n} + {R}_{displacement}$$

when optimizing the cost for the motion path (see eq. (6) and (7)). In a first stage of the optimization process, the first term in eq. 10 is optimized first over geo-modes, each of which includes a set of parameters that are applicable to the encoding of geometrical data (e.g., pertaining to base mesh encoding 135 and mesh displacement encoding 145). In a second stage of the optimization process, the second term is optimized over tex-modes, each of which includes a set of parameters that are applicable to the encoding of image data (e.g., pertaining to attribute map encoding 160). Note that in the second term,

$${R}_{g e o}^{mode}$$

represents the bitrate at the optimal geo-mode as determined by the first term optimization in the first stage.

Hence, in the first stage, the geo-mode that optimizes the first term of the cost (in eq. 10) for the static path is determined, resulting in an optimal geo-mode of the static path (namely, sp-opt-geo-mode). Likewise, the geo-mode that optimizes the first term of the cost (in eq. 10) for the motion path is determined resulting in an optimal geo-mode of the motion path (namely, mp-opt-geo-mode). Next, the corresponding bitrate values at the optimal geo-mode of the static path and the optimal geo-mode of the motion path are computed:

$${R}_{g e o}^{s p - g e o - mode} = {R}_{m e s h} + {R}_{displacement} , \qquad ( 11 )$$

$$and$$

$${R}_{g e o}^{mp - opt - g e o - mode} = {R}_{m o t i o n} + {R}_{displacement} . \qquad ( 12 )$$

Then, in the second stage, the tex-mode that optimizes J is determined for each of the static path and the motion path. Thus, an SP optimal cost that is associated with the static path can be determined based on the second term (in eq. 10), where

$${R}_{g e o}^{mode} = {R}_{g e o}^{s p - o p t - geo - mode} .$$

And, an MP optimal cost that is associated with the motion path can be determined based on the second term (in eq. 10), where

$${R}_{g e o}^{mode} = {R}_{g e o}^{mp - opt - geo - mode} .$$

Accordingly, the bitstream generated by the encoding path with the least optimal cost—the lower of the SP optimal cost and the MP optimal cost—can be selected as the output bitstream 560 of the encoder 500. Alternatively, the bitstream generated by the encoding path with the optimal cost (either the SP optimal cost or the MP optimal cost) that is lower than a predetermined threshold can be selected as the output bitstream 560 of the encoder 500.

The coding modes over which the rate-distortion cost J is optimized can each include any combination of parameters that control the operation of the SP encoder 520 and the MP encoder 525. For example, the rate-distortion cost J can be optimized, as described herein, over coding modes that are defined by parameters such as QPs that are set to control quantizers in the base mesh encoder 135, the mesh displacement encoder 145, and/or the attribute map encoder 160. Furthermore, the rate-distortion cost J can be optimized over coding modes that are defined by parameters associated with local QP adaptation, target resolution adaptation, and/or slice type adaptation.

In an aspect, a slice type, associated with the encoding 145, 160 of image data of a frame, can be coupled with the frame's selected encoding path. Thus, since image data of a frame, that is selected to be encoded by the static path, is likely to have a different layout compared to image data of the previous frame, the slice type can be conditioned by the selected encoding path. For example, if the output of the static path is selected for a frame, the slice type is set to intra. Otherwise, if the output of the motion path is selected for the frame, the slice type is set to inter. Using such heuristics, the search space of a rate-distortion optimization algorithm can be reduced.

In another aspect, the GOP structure of a GOP sequence can be adapted based on the selected encoding path. For example, since a sequence of frames F(i) for which the motion path has been selected is likely to be temporally stable, the GOP structure of such a sequence can be dynamically adapted. Techniques for GOP structure adaptation are further described below.

FIG. 6 is a diagram of an example GOP structure 600, according to an aspect of the present disclosure. A way to balance the rate-distortion costs across a GOP is to use a hierarchical GOP structure. In FIG. 6, the hierarchy of a GOP structure 600 is demonstrated by the frames' temporal depth and by the arrows that indicate inter-coding dependency between a frame and other reference frames. As illustrated, the first frame 610 of the GOP is an intra coded frame, and, therefore, does not rely on any other reference frames for its encoding. The following frames are inter coded frames that rely on other reference frames for their encoding. Thus, as indicated by the arrows, frame 615 relies on reference frames 610 and 620, frame 620 relies on reference frames 610 and 630, frame 625 relies on reference frames 620 and 630, and so on. The first cycle of the GOP structure (including frames 615, 620, 625, and 630) is repeated by a second cycle of the same GOP structure (including frames 635, 640, 645, and 650) and, similarly, by additional cycles, until a new intra frame is encoded at which stage a new GOP cycle begins.

Typically, each of the GOP's frames is assigned with a QP having a value that is related to the frame importance in the GOP. The importance of a frame is associated with its temporal depth and/or with the number of times the frame is referenced, directly or indirectly, by other frames. Table 1 shows the intra frame 610 and the frames in the first cycle of the GOP structure 615, 620, 625, 630, indicating these frames' picture order count (POC), slice type, QP offset, temporal depth (expressed by a temporal identity number—Tid), and associated reference frames.

TABLE 1
A GOP Structure.

| | | | | Reference |
|---|---|---|---|---|
| POC | Slice Type | QP offset | Tid | Frames |
| 0 | Intra | 0 | 0 | |
| 4 | Inter | 1 | 1 | −4, [−8] |
| 2 | Inter | 2 | 2 | −2, 2 |
| 1 | Inter | 4 | 3 | −1, 1 |
| 3 | Inter | 4 | 3 | −1, 1 |

The QP offset is the offset added to a target QP that is typically assigned to the whole GOP sequence. Thus, if the target QP is 32 and the QP offset of a frame is 2, then a QP of 32+2=34 is used to encode that frame. Note that the offset can be adapted depending on the content. The Tid indicates the temporal depth of a frame—the higher the Tid, the lowest the impact the frame has on the other frames. The reference frames are indicated by a POC delta, where when the POC delta is bracketed the indicated reference frame is used only if available. For example, frame 610 has a POC of 0, a slice type of intra, a QP of 32, a temporal depth of 0, and, being an intra frame, it relies on no reference frames. Frame 630 has a POC of 4, a slice type of inter, a OP of 33, a temporal depth of 1, and it relies on reference frame 610 (that is, its POC minus 4). In the second cycle, the corresponding frame 650 relies on frame 630 (that is, its POC minus 4) and on frame 610 (that is, its POC minus 8). The GOP structure is repeated, as shown in Table 2, where several cycles of the GOP structure are demonstrated. When a new intra frame is encoded, a new GOP sequence begins with a new cycle of the GOP structure. A GOP sequence and a GOP structure, as described herein, can be of arbitrary size, having a different number of temporal levels, and a different number of applied QP offsets.

TABLE 2
Repeated Cycles of A GOP Structure.

| | | | | | Reference |
|---|---|---|---|---|---|
| Cycle | POC | Slice Type | QP offset | TiD | frames |
| | 0 | Intra | 0 | 0 | |
| 1 | 4 | Inter | 1 | 1 | −4 |
| | 2 | Inter | 2 | 2 | −2, 2 |
| | 1 | Inter | 4 | 3 | −1, 1 |
| | 3 | Inter | 4 | 3 | −1, −1 |
| 2 | 8 | Inter | 1 | 1 | −4, −8 |
| | 6 | Inter | 2 | 2 | −2, 2 |
| | 5 | Inter | 4 | 3 | −1, 1 |
| | 7 | Inter | 4 | 3 | −1, 1 |
| 3 | 12 | Inter | 1 | 1 | −4, −8 |
| | 10 | Inter | 2 | 2 | −2, 2 |
| | . | . | . | . | . |

In an aspect, the GOP structure can be dynamically adapted to the selection 550 of a static path or a motion path encoding. For example, in low-delay encoding, the following GOP structure adaptation policy can be applied. The first frame of a GOP sequence is set as an intra frame and is encoded using the static path encoder 520. Then, the following frames of the GOP sequence are processed, starting with a first cycle of a GOP structure. Thus, for each of the following frames, the following steps may be carried out: 1) encoding according to the static path 520 is performed, using a QP offset of 0 and an intra slice type; 2) encoding according to the motion path 525 is performed, using the frame's assigned QP according to its position in the GOP structure and an inter slice type; 3) selecting 550 the bitstream generated by the more efficient encoding path (520 or 525) to form the output bitstream 560; 4) if the selected bitstream is generated by the static path 520, restarting the cycle of the GOP structure; and 5) proceeding to step 1) to process the next frame. The above GOP structure adaptation policy is further demonstrated in reference to Table 3 and Table 4.

TABLE 3
A GOP Structure

| | | | | Reference |
|---|---|---|---|---|
| POC | Slice Type | QP offset | TiD | Frames |
| 0 | Intra | 0 | 0 | |
| 1 | Inter | 3 | 3 | −1, [−5] |
| 2 | Inter | 2 | 2 | −2, −1 |
| 3 | Inter | 3 | 3 | −3, −1 |
| 4 | Inter | 1 | 1 | −4, −2 |

TABLE 4
Adaptive GOP Structure

| | | RD cost - | RD cost - | Se- | | | Refer- |
|---|---|---|---|---|---|---|---|
| | | static | motion | lected | Slice | | ence |
| Cycle | POC | mode | mode | mode | Type | QP | frames |
| | 0 | 1000 | — | static | intra | QP | |
| 1 | 1 | 1100 | 500 | motion | inter | QP + 3 | −1 |
| | 2 | 1050 | 600 | motion | inter | QP + 2 | −2, −1 |
| | 3 | 900 | 980 | static | intra | QP + 3 | −3, −1 |
| 2 | 4 | 1100 | 450 | motion | inter | QP + 3 | −1 |
| | 5 | 1000 | 500 | motion | inter | QP + 2 | −2, −1 |
| | 6 | 1010 | 510 | motion | inter | QP + 3 | −3, −1 |
| | 7 | 1020 | 600 | motion | inter | QP + 1 | −4, −2 |
| 3 | 8 | 1010 | 710 | motion | inter | QP + 3 | −1, −5 |
| | 9 | 1010 | 510 | motion | inter | QP + 2 | −2, −1 |
| | 10 | 1020 | 600 | motion | inter | QP + 3 | −3, −1 |
| | . | . | . | . | . | . | . |

Table 3 illustrates an GOP structure, indicating each frame's POC, slice type, QP offset, Tid, and associated reference frames. Using this GOP structure, Table 4 illustrates the process of adapting the GOP structure of a GOP sequence base on the GOP structure adaptation policy described above. Accordingly, the first frame (POC=0) is set as an intra frame and is encoded using the static path 520. Then, for the frame of POC=1, motion path encoding (using QP=QP+3 and an inter slice type) and static path encoding (using QP=QP+0 and an intra slice type) are performed, of which the bitstream generated by the motion path is selected based on the respective RD costs. Next, for the frame of POC=2, motion path encoding (using QP=QP+2 and an inter slice type) and static path encoding (using QP=QP+0 and an intra slice type) are performed, of which the bitstream generated by the motion path is selected based on the respective RD costs. Next, for the frame of POC=3, motion path encoding (using QP=QP+3 and an inter slice type) and static path encoding (using QP=QP+0 and an intra slice type) are performed, of which the bitstream generated of the static path is selected based on the respective RD costs. The selection of the bitstream generated by the static path for POC=3 prompts the restarting of a new cycle of the GOP structure when processing the next frame of POC=4, as demonstrated in Table 4.

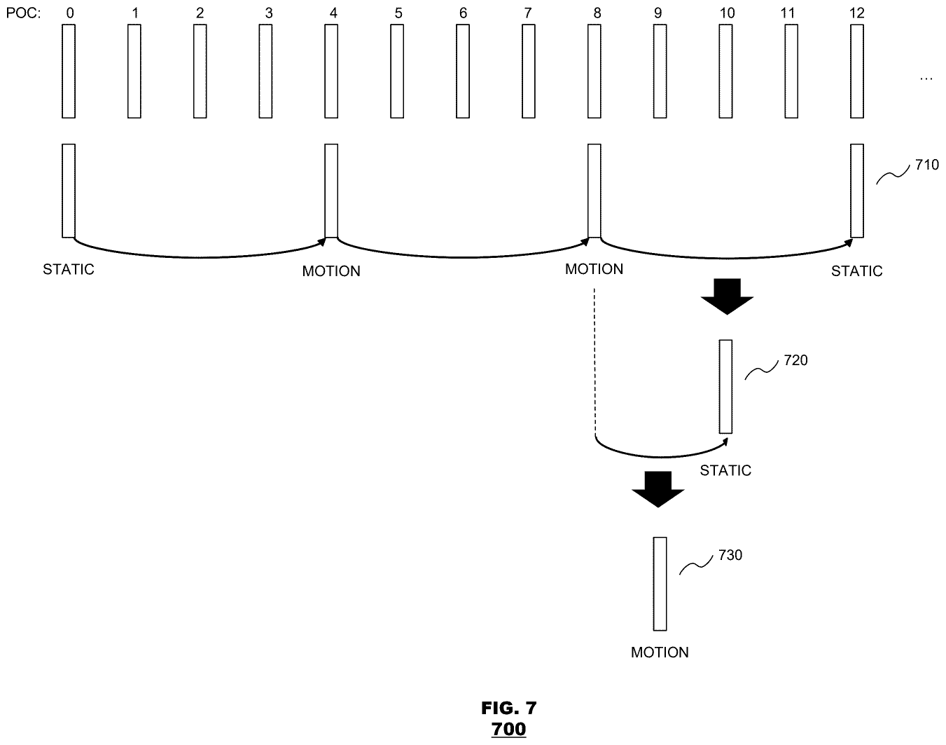

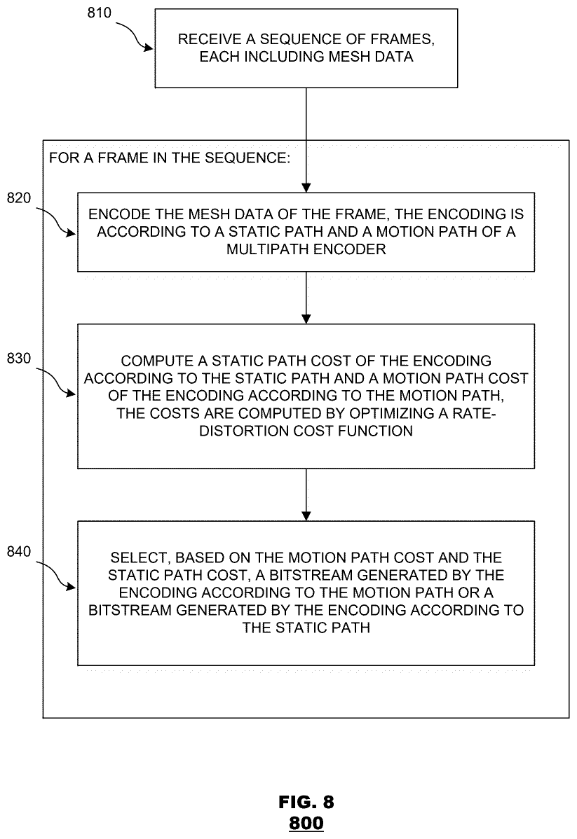

In a random access mode, the selection of whether to encode each frame of a GOP sequence using the static path 520 or using the motion path 525 can be done in two stages. In the first stage, frames in the GOP sequence for which the bitstream generated by the static path is selected are determined. These frames are referred to herein as static frames. In the second stage, the remaining frames are encoded using the motion path. A technique for determining the static frames in a sequence is described in reference to FIG. 7.

FIG. 7 is a diagram of an example method 700 for determining static frames in a GOP, according to an aspect of the present disclosure. Specifically, the method 700 determines the next static frame relative to a static frame S. To that end, in a first iteration 710, starting from a static frame S=0, frames S+k*G are evaluated up to M frames, where M is the maximum (allowed) number of consecutive motion frames and G is the GOP size (e.g., frames 0+k*4, for k=1, 2 . . . M/4 are evaluated). Thus, for each of these frames it is tested whether to select 550 the bitstream generated by the static path 520 or the motion path 525. As illustrated in FIG. 7, based on the testing of frames 4, 8, and 12, frame 12 is the first for which encoding in a static mode is selected. In a second iteration 720, the same process is repeated for the frames between 8 and 12, evaluating frames every G/2 frames. In this iteration 720, frame 10 is the first frame for which encoding in a static mode is selected. Then, in a third iteration 730, the same process is repeated for the frames between frames 8 and 10, evaluating frames every G/4. In this iteration 730, an encoding in a motion mode is selected for frame 9, and, thus, frame 10 is determined as the next static frame following static frame 0). Thus, the frames between frame 0 and frame 10 are encoded using the motion path (no need for these frames to test for the better encoding path). The method 700 repeats, starting from frame 10 (that is, S=10).

In an aspect, there is no need to perform a full testing (of whether to select 550) the bitstream generated by the static path 520 or by the motion path 525) when determining the first static frame. Instead, an approximate heuristic may be used. A typical heuristic may be based on the energy of a frame difference or based on the motion vectors amplitude.

FIG. 8 is a flow diagram of an example method 800 for multipath encoding. The method 800 begins, in step 810, by receiving a sequence of frames, containing mesh data. Then, for a frame in the sequence, steps 820 to 840 may be performed. In step 820, the mesh data of a frame of the sequence is encoded according to a static path and according to a motion path of a multipath encoder. Next, in step 830, a static path cost of the encoding according to the static path and a motion path cost of the encoding according to the motion path are computed. The costs may be computed by optimizing a rate-distortion cost function. Then, in step 840, based on the motion path cost and the static path cost, a selection is made between a bitstream generated by the encoding according to the motion path and a bitstream generated by the encoding according to the static path. In an aspect, the bitstream generated by the encoding according to the motion path may be selected if the motion path cost is lower than the static path cost. In another aspect, the bitstream generated by the encoding according to the motion path may be selected if the motion path cost is lower than a predetermined threshold.

As described above, the rate-distortion cost function comprises a geometrical term and a textural term (see eq. 5). In an aspect, the optimization of the rate-distortion cost function can be caried out in two stages (see eq. 10). In the first stage, the geometrical term of the rate-distortion cost function is optimized, resulting in an optimal mode (of the coding modes) and a respective bitrate. Then, in a second stage, the textural term of the rate-distortion cost function is optimized, where the textural term includes the respective bitrate, provided by the first stage. The optimization of the rate-distortion cost function is over coding modes, each of which including parameters that control the encoding of the mesh data of the frame. In an aspect, such parameters may be associated with a local QP adaptation, a target resolution adaptation, a slice type adaptation, or a combination thereof.

The method 800 may adapt a GOP structure of the received sequence of frames 810 based on the selection of bitstreams in step 840, as described in reference to Tables 3 and 4. To that end, for each frame in the sequence the following may be performed: 1) the frame is encoded 820 according to the static path, setting a slice type to intra and a quantization parameter to zero, 2) the frame is encoded 820 according to the motion path, setting a slice type to inter and a quantization parameter according to the frame position in the GOP structure, and, then 3) if the bitstream that is generated by encoding according to the static path is selected 840 then such selection causes the method 800 to restart a cycle of the GOP structure in the sequence of frames (as illustrated in Table 4).

The method 800 may also determine static frames and motion frames in a GOP, as described in reference to FIG. 7. For example, steps 820, 830, and 840 may be carried out by the method 800 for a subset of frames in the sequence, the subset follows a current frame for which the bitstream generated by encoding according to the static path is selected (e.g., frame 0 in FIG. 7). Next, a first frame in the subset is determined for which the bitstream generated by encoding according to the static path is selected. Then, the mesh data of frames between the current frame and the first frame may be encoded according to the motion path of the multipath encoder. The subset of frames may be a series of frames positioned at the end of cycles of a GOP structure of the sequence of frames (e.g., frames 4, 8, and 12 in FIG. 7), where the series ends with a frame for which the bitstream generated by encoding according to the static path is selected (e.g., frame 12). In an aspect, the first frame can be recursively determined among frames between a frame positioned at the beginning of the last cycle of the series (e.g., frames 8) and a candidate frame that was determined as the first frame in a previous iteration (e.g., frame 10 at iteration 720).

The illustrations of the aspects described herein are intended to provide a general understanding of the structure, function, and operation of the various aspects. The illustrations are not intended to serve as a complete description of all of the elements and features of apparatuses and systems that utilize the structures or methods described herein. Many other aspects may be apparent to those of skill in the art upon reviewing the disclosure. Other aspects may be utilized and derived from the disclosure, such that structural and logical substitutions and changes may be made without departing from the scope of the disclosure. Accordingly, the disclosure and the figures are to be regarded as illustrative rather than restrictive.

The description of the aspects is provided to enable the making or use of the aspects. Various modifications to these aspects will be readily apparent, and the generic principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. A method for encoding mesh data, comprising:
receiving a sequence of frames, each including mesh data; and
for a frame in the sequence:
encoding mesh data of the frame, the encoding of the mesh data comprises encoding geometrical data and textural data according to a static path and according to a motion path of a multipath encoder, wherein in the static path the geometrical data is coded independently and in the motion path the geometrical data is coded relative to geometrical data from a previous frame,
computing a static path cost of the encoding according to the static path and a motion path cost of the encoding according to the motion path, the costs are computed by optimizing a rate-distortion cost function, and
selecting, based on the motion path cost and the static path cost, a bitstream generated by the encoding according to the motion path or a bitstream generated by the encoding according to the static path.

2. The method according to claim 1, wherein the rate-distortion cost function comprises a geometrical term indicating a cost associated with the coding of the geometrical data and a textural term indicating a cost associated with the coding of the textural data.

3. The method according to claim 1, wherein the optimizing of the rate-distortion cost function is over coding modes, each mode including parameters that control the encoding of the mesh data of the frame according to the static path and according to the motion path.

4. The method according to claim 3, wherein the parameters of a mode of the coding modes are associated with one of a local QP adaptation, a target resolution adaptation, or a slice type adaptation.

5. The method according to claim 1, wherein the optimizing of the rate-distortion cost function comprises:
optimizing a geometrical term, of the rate-distortion cost function, determining an optimal mode, of coding modes applicable to the coding of the geometrical data, and a respective bitrate; and
optimizing a textural term, of the rate-distortion cost function, determining an optimal mode, of coding modes applicable to the coding of the textural data, wherein the textural term including the respective bitrate.

6. The method according to claim 1, wherein the selecting comprises:
selecting the bitstream generated by the encoding according to the motion path if the motion path cost is lower than the static path cost.

7. The method according to claim 1, wherein the selecting comprises:
selecting the bitstream generated by the encoding according to the motion path if the motion path cost is lower than a predetermined threshold.

8. The method according to claim 1, further comprising:
adapting a GOP structure of the sequence of frames based on the selecting, wherein a selection of the bitstream generated by the encoding according to the static path restarts a cycle of the GOP structure in the sequence.

9. The method according to claim 1, wherein the encoding according to the static path comprises setting a slice type to intra and a quantization parameter to zero.

10. The method according to claim 1, wherein the encoding according to the motion path comprises setting a slice type to inter and a quantization parameter according to the frame position in the GOP structure.

11. The method according to claim 1, further comprising:
performing the encoding, the computing, and the selecting for a subset of frames in the sequence, the subset follows a current frame for which the bitstream generated by the encoding according to the static path is selected;
determining a first frame in the subset for which the bitstream generated by the encoding according to the static path is selected; and
encoding the mesh data of frames between the current frame and the first frame according to the motion path of the multipath encoder.

12. The method according to claim 11, wherein the number of frames between the current frame and the first frame is below a maximum number of consecutive motion frames.

13. The method according to claim 11, wherein the subset of frames comprises:
a series of frames positioned at the end of cycles of a GOP structure of the sequence of frames, the series ends with a frame for which the bitstream generated by the encoding according to the static path is selected.

14. The method according to claim 11, wherein the determining of the first frame comprises:
recursively determining the first frame among frames between a frame positioned at the beginning of the last cycle of the cycles and a candidate frame, determined as the first frame in a previous iteration.

15. An apparatus for encoding mesh data, comprising:
at least one processor; and
memory storing instructions that, when executed by the at least one processor, cause the apparatus to:
receive a sequence of frames, each including mesh data, and
for a frame in the sequence:
encode mesh data of the frame, the encoding of the mesh data comprises coding geometrical data and textural data according to a static path and according to a motion path of a multipath encoder, wherein in the static path the geometrical data is coded independently and in the motion path the geometrical data is coded relative to geometrical data from a previous frame,
compute a static path cost of the encoding according to the static path and a motion path cost of the encoding according to the motion path, the costs are computed by optimizing a rate-distortion cost function, and
select, based on the motion path cost and the static path cost, a bitstream generated by the encoding according to the motion path or a bitstream generated by the encoding according to the static path.

16. The apparatus according to claim 15, wherein the rate-distortion cost function comprises a geometrical term indicating a cost associated with the coding of the geometrical data and a textural term indicating a cost associated with the coding of the textural data.

17. The apparatus according to claim 15, wherein the optimizing of the rate-distortion cost function is over coding modes, each mode including parameters that control the encoding of the mesh data of the frame according to the static path and according to the motion path of the multipath encoder.

18. The apparatus according to claim 17, wherein the parameters of a mode of the coding modes are associated with one of a local QP adaptation, a target resolution adaptation, or a slice type adaptation.

19. The apparatus according to claim 15, wherein the optimizing of the rate-distortion cost function comprises:
optimizing a geometrical term, of the rate-distortion cost function, determining an optimal mode, of coding modes applicable to the coding of the geometrical data, and a respective bitrate; and
optimizing a textural term, of the rate-distortion cost function, determining an optimal mode, of coding modes applicable to the coding of the textural data, wherein the textural term including the respective bitrate.

20. The apparatus according to claim 15, wherein the selecting comprises:
selecting the bitstream generated by the encoding according to the motion path if the motion path cost is lower than the static path cost.

21. The apparatus according to claim 15, wherein the selecting comprises:
selecting the bitstream generated by the encoding according to the motion path if the motion path cost is lower than a predetermined threshold.

22. A non-transitory computer-readable medium comprising instructions executable by at least one processor to perform a method for encoding mesh data, the method comprising:
receiving a sequence of frames, each including mesh data; and
for a frame in the sequence:
encoding mesh data of the frame, the encoding of the mesh data comprises encoding geometrical data and textural data according to a static path and according to a motion path of a multipath encoder, wherein in the static path the geometrical data is coded independently and in the motion path the geometrical data is coded relative to geometrical data from a previous frame,
computing a static path cost of the encoding according to the static path and a motion path cost of the encoding according to the motion path, the costs are computed by optimizing a rate-distortion cost function, and
selecting, based on the motion path cost and the static path cost, a bitstream generated by the encoding according to the motion path or a bitstream generated by the encoding according to the static path.
